(19) United States
(12) Patent Application Publication
(10) Pub. No.: US 2006/0292265 A1
(43) Pub. Date: Dec. 28, 2006

(54) FERMENTED MILK PRODUCT AND PROCESS

(76) Inventors: Robert Petermann, Konolfingen (CH); Christian Dupas, Lisieux (FR); Alfred Messerli, Grosshochstetten (CH)

Correspondence Address: BELL, BOYD & LLOYD LLC, P. O. BOX 1135, CHICAGO, IL, 60690-1135, US

(21) Appl. No.: 11/463,159

(22) Filed: Aug. 8, 2006

Related U.S. Application Data
(62) Division of application No. 10/081,788, filed on Feb. 22, 2002.
Application No. 10/081,788 is a continuation-in-part of application No. PCT/EP00/07121, filed on Jul. 24, 2000.
Application No. PCT/EP00/07121 is a continuation-in-part of application No. PCT/EP00/05945, filed on Jun. 26, 2000.

(51) Int. Cl. A23C 9/12

(52) U.S. Cl. 426/34

(57) ABSTRACT

A composite unripened curd cheese product is made by concomitantly side by side filling of distinct adjoining masses in a pot. A first mass may be a fermented milk base or at least one flavoring composition while a second mass is a fermented milk base. These masses are generally of contrasting colors and are arranged side by side such that there is no substantial migration of one mass into the other and each mass is accessible for consumption. To do this, the pot has a base, at least one sidewall extending from the base for defining the filling volume and an open top, and the masses are arranged along the sidewall so that each is accessible through the open top.

### PRIORITY CLAIM

This application is a divisional of U.S. patent application Ser. No. 10/081,788 filed on Feb. 22, 2002, now abandoned, which is a continuation-in-part of the U.S. national stage designation of International Application No. PCT/EP00/07121 filed Jul. 24, 2000, which is a continuation-in-part of the U.S. national stage designation of International Application No. PCT/EP00/05945 filed Jun. 26, 2000, the entire disclosures of which are expressly incorporated herein.

### BACKGROUND

The present invention relates to a composite soft unripened curd fermented milk product in a pack and a process for producing it.

Unripened Petit-Suisse type of cheese is traditionally prepared by curdling milk with lactic acid formed by lactic starter bacteria, separating the curd from the whey by centrifugal separators or draining the whey from the curd in bags, mixing cream to the drained curd and finally forming and packing optionally lined with paper in thermoformed pots. The forming operation can be carried out before packing or during packing in the case of stirred curd and in this latter case the form is given by the pot and the mass is dosed by means of a volumetric dispenser.

U.S. Pat. No. 5,194,283 discloses semi-hard ripened or unripened curd composite cheese products that are manufactured by co-extrusion at a temperature of from 0 to 30° C. In the particular embodiment of two different unripened drained curds, co-extrusion has limitations in the case of curd dosed into pots: in particular, one curd must predominantly surround the other a concentric extrusion is the best way to obtain a visually acceptable design pattern when the different curds are of contrasting colors.

There is a need for producing composite soft unripened curd fermented milk products of new visually attractive presentation which are appealing to the consumers, particularly to the kids and toddlers. The present invention mow satisfies this need.

### SUMMARY

The present invention relates to a composite fermented milk product comprising a pot defining a filling volume and containing distinct adjoining masses. A first mass comprises a fermented milk base or at least one flavoring composition and a second mass comprises a fermented milk base. Advantageously, the masses are of contrasting colors and are arranged side by side such that there is no substantial migration of one mass into the other and each mass is accessible for consumption. To do this, the pot has a base, at least one sidewall extending from the base for defining the filling volume and an open top, and the masses are arranged along the sidewall so that each is accessible through the open top.

When a non-linear arrangement of masses is desired, the masses can be arranged to extend along the sidewall on a spiral or zigzag path. This can be done by rotating the pot during filling or by rotating the filling nozzle(s) as the masses are filled into the pot.

In a basic arrangement, two masses are present, but when more than two adjoining masses are used, they meet at a common vertical axis of symmetry within the volume of the pot. In this arrangement, one of the masses would not be a fermented milk base. To avoid intermixing or migration of the masses during filling and storage, the global viscosity of each mass is preferably controlled to be about the same value.

The invention also relates to a process for the production of a composite fermented milk product which comprises: providing a pot that defines a filling volume; separately preparing first and second adjoining masses including a first mass comprising a fermented milk base or at least one flavoring composition and a second mass comprising a fermented milk base; and concomitantly side by side filling of the pot with substantially equivalent volumes of at least the first and second masses. In this process, the viscosities and temperatures of the masses are controlled so that there is no substantial migration of one mass into the other and each mass is accessible for consumption.

### DETAILED DESCRIPTION

The invention preferably relates to a composite soft unripened curd fermented milk product in a pack in the form of a pot defining a filling volume comprising at least two distinct adjoining masses. These masses include: at least one fermented milk base and at least one flavoring composition or at least two fermented milk bases, wherein the base(s) and the flavoring composition(s) are of contrasting colors, are arranged side by side and the interface between the contrasting base(s) and flavoring composition(s) is a median surface within the volume of the pot.

In the product of the invention, the contrasting masses in the pot adjoin at an interface. Thus if the product consists of an even number, e.g. two adjoining masses, they meet at a common median plane of symmetry. If the product consists of an odd number, e.g., three adjoining masses, they meet at a common vertical axis of symmetry.

In some cases, filling can be carried out under rotation and the interface of the adjoining masses is then a twisted median surface in the pot.

In the context of the invention, a fermented milk base may comprise unripened cheese curd. Unripened cheese curd may be obtained by known techniques. One conventional technique comprises curdling milk with lactic bacteria and rennet, separating whey by centrifugation or ultrafiltration and thus obtaining coagulated concentrated milk. Another conventional technique so called “direct curd” consists in first concentrating milk by ultrafiltration and/or addition of milk protein concentrate, adding lactic starters and rennet to the concentrated liquid to obtain a coagulated concentrated milk without draining.

A fermented milk base may comprise other fermented products such as stirred yoghurt, fermented milk, fermented vegetable curd or fermented cereal whenever necessary together with a stabilizer to obtain a gellified mass of required viscosity.

The fermented milk base may comprise added fats which can be milk fat, vegetable fats or mixtures of such fats, particularly vegetable fats providing essential fatty acids such as linoleic and alpha-linolenic acids.

The flavoring composition may be of savory nature and contain salt, spices, herbs, flavorings, colorants, purees or pieces of vegetables, cereals. Alternatively, the flavoring composition may be of a sweet nature and contain sugar, honey, syrup, flavorings, colorants, pulps or pieces of fruit, which latter may be dried, preserved or candied, cereals. It also can be a compote, jam, marmalade, or preserve.

The flavoring composition is advantageously stabilized with suitable stabilizers giving to it the necessary consistency for extrusion. Preferred stabilizers comprise food gums, such as e.g., locust bean gum, guar gum, xanthan gum, starches, preferably short texture native or modified starch and pectin, used individually or in admixture.

The texture of the fermented base must be stable during time and compatible with side by side filling. It has been found that viscosity of the fermented milk base and the flavoring composition as components of the composite product is a key parameter for side by side filling the product into pots. Thus a viscosity of from 5000 to 15000 mPa·s using a Brookfield type viscometer at 10° C., 50 rpm/disk 5 gives satisfactory results. Preferably, the global viscosities of the different components of the composite product are about the same so that migration of one mass into the other(s) is substantially avoided. Temperature is also an important consideration in achieving the distinctiveness of the masses in the pot.

In one, embodiment, the product consists of two masses; a fermented milk base and a flavoring composition.

In another embodiment, the product may consist of two distinct fermented milk bases which can also be flavored or colored differently.

Preferably, the fermented milk base comprises: from 50 to 70% by weight lactic curd of plastic consistency of about 12 to 22% dry matter by weight, from 5 to 20% by weight cream and from 10 to 30% by weight of a sweet or fruit preparation.

The sweet or fruit preparation in the fermented milk base preferably comprises a stabilizer. Preferred stabilizers comprise food gums, such as e.g., locust bean gum, guar gum, xanthan gum, starches, preferably short texture modified starch and pectin, used individually or in admixture.

The amount of stabilizer used preferably is from 0.5 to 2% by weight and most preferably from 0.5 to 1.5% by weight of the sweet or fruit preparation.

Thus, the viscosity value of the preferred fermented milk base may be obtained by adapting the viscosity of the sweet or fruit preparation to preferably from 4000 to 8000 mPa·s. (Brookfield, 25° C./15 s, 50 rpm/disk 5).

The fermented milk bases have a high amount of proteins and carbohydrates. They may be enriched in vitamins, e.g., A, E, D and C and minerals, e.g., calcium, potassium, etc. This is important for children, particularly toddlers who have specific nutritional needs due to their physiology requiring more energy, proteins and nutrients.

Side by side filling provides for very interesting organoleptic and nutritional advantages. Contrasting colors may be associated with contrasting taste sensations. The arrangement of the masses in the pot enable the consumer to access each mass individually. Thus, at the consumer's choice, the different products may be consumed alternately at the same time or one after the other.

From the nutritional point of view, since the fermented milk bases are stabilized and in juxtaposed layers there is no substantial migration of ingredients from one base to the other. Thus the fermented bases may contain probiotic strains in one base and dietary fibers, especially prebiotics in the form of soluble fibers which help in building healthy intestinal flora and prevent digestive problems in the other base.

The fermented milk bases may also be aerated to lighten their texture. An aerated curd thus assumes the form of a cheese mousse. Such a mousse preferably contains from about 0.5 to 3% by weight of a stabilizer or of a stabilizer/emulsifier blend typically used in ice creams. The curd is preferably aerated to an overrun of up to 120%, most preferably of from 50 to 120% with an inert gas, for example nitrogen or air.

The fermented milk bases may contain inclusions such as pieces of fruit or flavorings, for example cocoa, chocolate, or nuts.

In a preferred way for carrying out the process of the invention, two distinct masses for example two moist unripened cheese curds of plastic consistency are fed, for example by single or double Archimedes screws, or by any other positive pump to hoppers, which can be pressurized.

From the hoppers controlled valves allow feeding of the two masses to dosing cylinders and from there by dosing pistons through pipes to filling head comprising two essentially parallel and vertical filling nozzles and from there into pots carried by a conveyor belt or chain moving step by step underneath.

In this case the filling of a pot consists of two half-portions and each half-portion is metered by means of a portion control mechanism. This mechanism may preferably comprise upstream of the nozzle a connecting pipe through which the product is delivered to the nozzle and which may be closed and opened by means of a controlled valve. The valve is upstream of a passage in the nozzle. Preferably, the valves are resilient membranes which are controlled by air pressure. The metering chambers consist of the piston cylinders and the pipe section upstream of the membranes. Thus the passageways including the connecting pipes and the passages in the nozzles are preferably optimized in order to provide symmetric flow paths for the distinct products forming the half portions for improved filling accuracy while limiting steric hindrance and providing for a compact design of the filling head.

Preferably, the dosing pistons are driven individually to allow for adjustment of dosing speed, by means of a variator of the dosing piston driving motor. This can provide for slightly delayed filling of one mass respective to the other for accurate side by side filling when the viscosities of the masses are not exactly the same.

The pots are presented under the filling head. For proper filling without any air pockets being formed, the filling head preferably is mounted on a vertically movable (i.e., up-and-down) device by which the nozzles descend into the pots in proximity of their bottoms and fill them while they are lifted. Thus the connecting pipes between the dosing cylinders and the nozzles are flexible. During the filling operation the pots are stationary. After being filled the pots advance one step.

A pair of filling nozzles which deliver each a half-portion into a pot may be mounted on a rotary joint thus providing two complementary half-portions of spiral shape. In a variant, a device, for example a permanently rotating plate placed beneath the conveyor may lift the pot so that it surrounds the nozzles and impart a downward spinning movement to it during the filling process, the filling head remaining stationary.

The pots used may be of cylindrical or frustoconical shape with a circular, oval or square opening or e.g. frustoconical with an opening in the form of a stylized heart. The pots may be opaque or advantageously transparent to show the contrasted layers. A useful filling volume may preferably be between about 20 to 200 cm³.

Preferably, the pots are in multiple packs and thermoformed, filled and sealed with lids in a form-fill-seal equipment.

### EXAMPLES

The following Examples illustrate the invention. In these Examples, percentages and parts are by weight, unless otherwise stated.

### Example 1

### Preparation of Fruit Petit Suisse, Fermented Base 1

Unripened curd was prepared in a standard way from skimmed milk standardized to 10% solids non fat, pasteurized, cooled to ambient temperature and inoculated with mesophilic lactic starter, CaC12 and rennet. After fermentation to pH 4.5-4.6 the curd was broken into small pieces, thermized for a few min., cooled and drained by centrifugation to 16.2% total solids.

A strawberry fruit preparation was obtained by melting frozen fruit and mixing with granulated sucrose, stabilizers, citric acid, whey and water. After pasteurization, the mixture was cooled to 65° C., colorings, flavorings, potassium sorbate and vitamins were added. The fruit preparation contained 63.5% dry matter (Brix refractometer) and was stabilized with 1.5% of a mixture of locust bean gum (LBG) and short texture modified starch, containing predominantly locust bean gum. The fruit preparation had a viscosity of 5496 mPa·s (Brookfield, 25° C./15 s, 50 rpm/disk 5).

To 63% of the preceding curd was added 10% pasteurized cream containing 45% fat and 27% preceding fruit preparation and the mixture was cooled to 10° C. in a plate heat exchanger.

The fermented base had a total solids content of 30.5% and a viscosity of 9.200 mPas at 10° C. (filling temperature).

### Preparation of Plain Petit Suisse, Fermented Base 2

Plain Petit Suisse was prepared as for the strawberry flavored version but without frozen fruit, coloring and flavoring in the sweet preparation added to the curd and cream, replacing them by whey. The added preparation contained 64.1% dry matter (° Brix) and had a viscosity of 5512 mPa·s (Brookfield, 25° C./15 s, 50 rpm/disk 5).

To 63% of the preceding curd was added 10% pasteurized cream containing 45% fat and 27% preceding sweet preparation and the mixture was cooled in a plate heat exchanger.

The fermented base had a total solids content of 29.9% and a viscosity of 9050 mPa·s at 10° C. (filling temperature).

### Preparation of the Composite Products

Both masses of fermented bases 1 and 2 were fed to pressurized hoppers which pressure was controlled individually and dosed into thermoformed frustoconical pots of plastic material containing 65 g of product with openings in the form of a stylized heart with a form-fill-seal filling machine.

Filling of pots carried by a step by step conveyor was carried out by parallel nozzles in a flexible filling head provided with a device for up-and-down movement, comprising entering the nozzles into the pots for filling, and lifting the nozzles out of the pots after filling. The filling time was about 0.8 s. Membrane dosing pumps with common motor drive control were used for simultaneously side-by-side filling of both masses. The masses were distributed by flexible connecting pipes to the nozzles.

The products had a pleasant appearance with well-defined medium separation plan between the two contrasting red and white masses.

### Example 2

The process of Example 1 was carried out with similar results, the difference being that the fruit preparation (fermented mass 3) and the sweet preparation (fermented mass 4) of the fermented masses were stabilized with 0.75% calcium reactive pectin dissolved in hot water.

The added fruit preparation of fermented mass 3 contained 64.1% dry matter (° Brix) and had a viscosity of 6440 mPa·s (Brookfield, 25° C./15 s, 50 rpm/disk 5).

The added sweet preparation of fermented mass 4 contained 64.1% dry matter (° Brix) and had a viscosity of 7631 mPa·s (Brookfield, 25° C./15 s, 50 rpm/disk 5).

### Example 3

The process of Example 1 was carried out with similar results with two fruit preparations, fermented masses 5 and 6. In fermented mass 5, strawberry flavored and in fermented mass 6, banana flavored the fruit preparations were stabilized with 0.6% of a mixture of LBG and xanthan gum where LBG was predominant. In addition, the masses contained 2.5% added calcium from added lactic mineral concentrate, corresponding to 240 mg calcium per 100 g product.

The added fruit preparation of fermented mass 5 contained 66.5% dry matter (° Brix) and had a viscosity of 8980 mPa·s (Brookfield, 25° C./15 s, 50 rpm/disk 5).

The added sweet preparation of fermented mass 6 contained 66.5% dry matter (° Brix) and had a viscosity of 8640 mPa·s (Brookfield, 25° C./15 s, 50 rpm/disk 5).

In addition, calcium stability was good in accelerated storage tests after 7 days storage at 30° C.

### Example 4

The process of Example 1 was carried out with similar results using plain Petit Suisse and fruit compote for the preparation of the composite product. The plain unripened cheese composition was similar to the indications given in Example 1 (fermented base 2).

The fruit compote was composed of 82% fruit, 16% sucrose and 2% stabilizer mix of LBG and pectin. The fruit compote viscosity was 9100 mPa·s (Brookfield, 25° C./15 s, 50 rpm/disk 5).

### Example 5

The process of Example 1 was carried out with similar results using as fermented milk bases milk fermented at 40° C. with thermophilic lactic bacteria (Lactobacillus bulgaricus, Streptococcus thermophilus), one flavored with a first fruit preparation (fermented mass 7) and the other with a distinct fruit preparation (fermented mass 8). The fermented milk bases had the following composition:

| Ingredient | % |
|---|---|
| Milk (3.5% fat) | 72.8 |
| Skimmed milk powder | 3 |
| Starter culture | 3 |
| Sucrose | 10 |
| Fruit preparation | 10 |
| Stabilizer (0.7% gelatine and 0.5% starch) | 1.2 |

The products had a pleasant appearance with well-defined medium separation plan between the two contrasting masses.

The invention is claimed as follows:

1. A process for the production of a composite fermented milk product which comprises:
providing a pot that defines a filling volume;
separately preparing first and second adjoining masses including a first mass comprising a fermented milk base or at least one flavoring composition and a second mass comprising a fermented milk base;
and concomitantly side by side filling of the pot with substantially equivalent volumes of at least the first and second masses;
wherein the viscosities and temperatures of the masses are controlled so that there is no substantial migration of one mass into the other and each mass is accessible for consumption.

2. The process of claim 1, wherein the temperatures of the masses is controlled to be within the range of from about 0° C. to 50° C. and the viscosities of the said masses are adjusted to values corresponding to from about 5000 to 15000 mPa·s.

3. The process of claim 1, which further comprises feeding two distinct masses of plastic consistency to hoppers, in which controlled valves allow feeding of the two masses to dosing cylinders and from there by dosing pistons through pipes to a filling head comprising two essentially parallel and vertical filling nozzles and from there into pots carried by a conveyor belt or chain moving step by step underneath, and in which the filling of a pot consists of two half-portions and each half-portion is metered by means of a portion control mechanism.

4. The process of claim 3, in which the portion control mechanism comprises upstream of the nozzle a connecting pipe through which the product is delivered to the nozzle and which may be closed and opened by means of a controlled valve, in which the valve is upstream of a passage in the nozzle, the metering chambers consist of the piston cylinders and the pipe section upstream of the valve and in which the passageways including the connecting pipes and the passages in the nozzles provide symmetric flow paths for the distinct masses forming the half-portions for improved filling accuracy whilst limiting steric hindrance and providing for a compact design of the filling head.

5. The process of claim 3, wherein the dosing pistons are driven individually to allow for adjustment of dosing speed, by means of a variator of the dosing piston driving motor, which provides for slightly delayed filling of one mass respective to the other for accurate side by side filling when the viscosities of the masses are not exactly the same.

6. The process of claim 3, wherein for proper filling without any air pockets being formed, the filling head preferably is mounted on an vertically movable device by which the nozzles descend into the pots in proximity of their bottoms and fill them while the device lifts the nozzles.

7. The process of claim 1, wherein filling of the pot is carried out under rotation so that anon-linear masses can be filled and arranged in the pot.

8. The process of claim 1, wherein more than two distinct masses are provided such that they meet at a common vertical axis of symmetry within the volume of the pot, with at least one of the masses not being a fermented milk base, with at least one mass not being a fermented milk.

9. The process of claim 12, wherein each mass has a global viscosity of between 5000 and 15000 mPa·s and the fermented milk base of at least one of the masses comprises: from about 50 to 70% by weight lactic curd of plastic consistency of about 12 to 22% dry matter by weight, from about 5 to 20% by weight cream, and from about 10 to 30% by weight of a sweet or fruit preparation.
